(19) United States
(12) Patent Application Publication
(10) Pub. No.: US 2002/0120751 A1
(43) Pub. Date: Aug. 29, 2002

(54) Control channel protocol and hardware-independent downstream services software design for broadband devices

(76) Inventor: Chris Del Sordo, Souderton, PA (US)

Correspondence Address: LAW OFFICE OF BARRY R LIPSITZ, 755 MAIN STREET, MONROE, CT, 06468, US

(21) Appl. No.: 09/791,290

(22) Filed: Feb. 23, 2001

(51) Int. Cl. G06F 15/16

(52) U.S. Cl. 709/228; 709/250

(57) ABSTRACT

A broadband terminal device that receives messages containing data destined for client applications running on the terminal. The messages are received by a control channel router via one or more input ports. The router removes the payload data from the messages and distributes the data to client applications in accordance with a predetermined priority of the ports which receive messages and requests made by client applications for the data. The terminal also includes a service acquisition interface that enables the client applications to establish connections to receive the data such that the requests made by applications for data may be hardware and protocol independent.

### FIELD OF THE INVENTION

The present invention relates to downstream data transmission in a broadband environment. In particular, the present invention relates to the processing of downstream data by platform software resident in a terminal operating within the broadband environment.

### BACKGROUND OF THE INVENTION

Broadband devices, such as digital broadband terminals, continue to gain increased functionality with respect to the processing of input data from a remote device to a client process resident in the broadband terminal. Various client processes, which may include software applications such as program guides, video-on-demand services, Web Browsing services, stock ticker services, and the like rely on the reception of input data from the remote device external to the broadband terminal. These remote devices could be located at a cable or telephone head-end, a remote server connected to the terminal via the Internet, Personal Computer that is resident in the consumer's home, a home theatre device that is resident in the consumer's home, or the like.

As can be seen in FIG. 1, this downstream data may be communicated to the broadband terminal 30 via many differing communication paths, such as in-band or out-of-band packet processor ports 14, Ethernet port 10, DOCSIS Cable Modem Port 20, USB port 18, parallel port 12, VBI (Vertical Blanking Interval) port 22, telephone modem port 24, IEEE 1394 (Firewire) port 16, or other suitable communication paths. FIG. 1 also shows that platform software 28 in the broadband terminal 30 provides support for an assortment of communication protocols in order to receive this data. Examples of the supported protocols include: DCII and MPEG II, DOCSIS1.1, Ethernet, SLIP, USB, NABITZ, IEEE1394 and various phone modem protocols.

The present invention provides methods for the broadband terminal platform software 28 to isolate client applications 160 from the complexities of having to know detailed knowledge of the hardware and/or the communication protocols. Conventional broadband terminal software does not provide this support, which leads to a duplication of the various protocol support software in each of the application modules, which is wasteful in terms of code space and, more disadvantageously, prone to errors. Furthermore, it is disadvantageous from the application software's perspective to know the details of the hardware and communication protocols, since it does not allow high-level client software to be portable from one broadband terminal to another.

Moreover, it is also desirable for application software to work in different broadband environments.

Another limitation of conventional broadband terminal platform software is the lack of a mechanism whereby the client applications are able to obtain data by making a simple, generic call for data. It is also important that applications do not rely on any single path to receive this data because from one broadband environment to another, the data may come in from a different path using a different protocol. Still another problem is that conventional broadband terminal device's need for the platform software to coordinate message distribution to many client applications at the same time. It is crucial that the platform code provide a mechanism to promote harmony amongst simultaneous running applications since it is extremely likely that the client applications will not work harmoniously together at the same time. Another feature that should be provided by the platform software is a message throttling mechanism that stops one client application from starving out another client application.

The present invention provides a solution to the above-mentioned needs, as well as other advantages. In addition, the present invention also provides an improved message distribution system within the broadband terminal device, such that messages are distributed to client applications in a efficient manner.

### SUMMARY OF THE INVENTION

The present invention relates to downstream data transmissions in a cable television broadband environment. According to a first aspect of the invention, a broadband terminal device is to execute client application programs that request data. The broadband terminal includes a plurality of input ports that receive messages containing data. The platform software's message distribution engine includes a control channel router that receives the messages from the input ports and distributes the data to client applications in accordance with client application requests for the data. The platform software also includes a service acquisition interface that enables the client application programs to establish connections to receive the data by requesting the data independently of a message protocol or a port from which the data is received by the broadband terminal device. The control channel router may also be adapted to perform filtering of messages as defined by each client application program.

According to one feature of the invention, the connections are established by client applications using a source name, and the source name is independent of a port from which the data is to be received or a protocol by which the data is communicated. The source name may correlate to one of a specific path, a specific port, and a specific device from which the data is to be received.

According to another feature, a connection store may be provided that stores specific hardware and service acquisition-related information to establish the connections between client applications and ports from which the data is to be received. The connection store may issue a connection ID for use by the client application. The service acquisition interface may provide each client application program with the connection ID issued by the Connection Store, which connection ID is used to make the client application requests for the data. The client application requests preferably are made only when client applications are ready to receive the data. Client application requests for downstream data may be prioritized in accordance with predetermined criteria so that a particular client application's requests for data are controlled, such that other client applications remain capable of receiving data when requested by the other client applications. The predetermined criteria may comprise a priority of a specific input port from which the downstream data is to be received or a priority of a particular client application's thread.

According to a further feature, the control channel router determines from which port the message is received, determines a protocol associated with that port and message, and distributes only the payload portion of the received message containing the data to client applications. The control channel router may also perform DCII segment reassembly and IP fragment reassembly before passing the data off to the client.

According to another aspect of the invention, there is provided a terminal device adapted to operate within a broadband environment and running a plurality of client applications that includes a plurality of input ports that receive data, and platform software residing on the terminal device that controls the processing of the data in accordance with the client application requests for the data and a predetermined priority of the input ports.

According to a further feature of the invention, the client applications establish a connection to receive data by identifying a source name to the platform software, and the source name is independent of the input ports. In addition, the platform software may use the source name to determine a corresponding input port from which data is to be routed to the client applications. The client applications may request data using a predetermined call made to the platform software indicating that it is ready to receive data and the platform software may distribute data to the client applications only when the client applications have signaled that they are ready to receive data.

According to another aspect of the invention, there is provided a method of routing messages to client applications within a broadband terminal device from at least one input port, comprising: receiving, at a router, an event indicative of the receipt of a message at an input port; searching through a database to determine if there is a client application for which the data contained in the message is destined; and sending the data to the client if there is a client application for which the data is destined, or otherwise discarding the message.

The client applications may asynchronously request data by issuing requests that are stored in the database. In addition, the method may further include the steps of constructing a header of the message relevant to the input port and calling a filter function to filter received messages in accordance with client defined filtering.

### BRIEF DESCRIPTION OF THE DRAWINGS

The foregoing summary, as well as the following detailed description, is better understood when read in conjunction with the appended drawings. For the purpose of illustrating the invention, like references numerals represent similar parts throughout the several views of the drawings, it being understood, however, that the invention is not limited to the specific methods and instrumentalities disclosed. In the drawings:

FIG. 1 illustrates a block diagram of the various input ports within a broadband terminal and protocols supported by the broadband terminal platform software in accordance with the present invention;

FIG. 2 illustrates an example of a channel message distribution system in the broadband terminal in accordance with the present invention; and

FIG. 3 illustrates an example of the processes performed by the broadband terminal in routing messages to client applications.

### DETAILED DESCRIPTION OF THE INVENTION

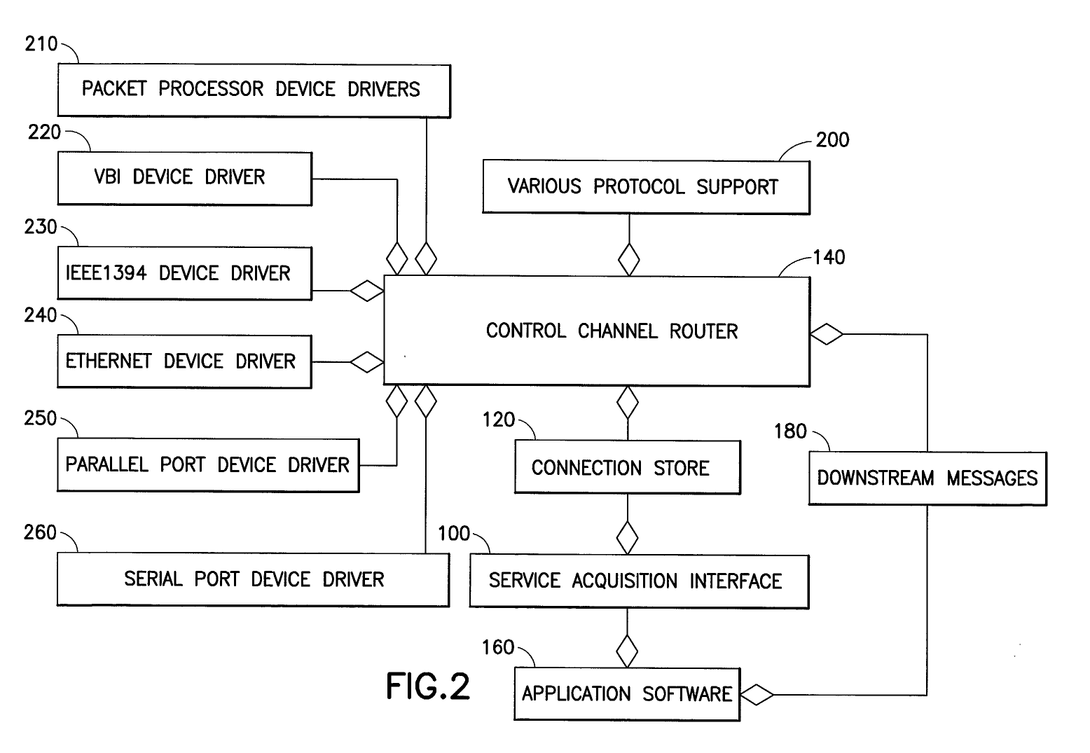

Referring to FIG. 2, the basic architecture of the present invention includes several central components, namely, a Service Acquisition Interface 100, a Connection Store 120, and a Control Channel Router 140. These components work hand-in-hand to provide client applications 160 the ability to request downstream data 180 and to gain access to the downstream data 180 received as input to the broadband terminal 30 in the broadband environment.

The service acquisition component 100 provides a generic interface for client applications 160 to establish a “connection” for a specific message regardless of the input path or for all messages from a specific path. An identifier (a source name) is passed by the client application 160, which identifies the specifics of the particular message type that the application 160 wants to receive, or all the messages from a particular path that the application 160 is interested in receiving. For example, if a client application, such as an electronic program guide (EPG), wants to receive all EPG data sent downstream from an EPG server remotely located at a cable head-end, the EPG application need only specify, e.g., “XYZappEPGdata” as a source name, and the Service Acquisition Interface 100 would then set-up the necessary hardware and store specific information in the Connection Store 120. Thereafter, a “connection” would be established. Examples of sources of messages from a specific path include, but are not limited to, a client application asking for all the messages on a specific PID stream; all the messages that come from a particular device on the USB; all the messages that come from a device on the IEEE1394 port; and all the messages received on a particular VBI (Vertical Blanking Interval) line. Alternatively, the client application 160 may ask for a specific message type regardless of the path the message.

The client application 160 also passes information in a pointer to a function that will allow a specific software filter capability that will be used to provide the data to the client application 160 once the data is received by the Control Channel Message Router 140. The software filter may examine the incoming data to determine if the data should be passed by the Control Channel Message Router 140 to a particular client application 160 based on certain criteria (e.g., if it is a redundant message, data identifiers, and the like). Once the Service Acquisition Interface 100 carries out all the necessary service acquisition steps, the client application 160 then receives a connection ID. This connection ID is used when issuing each “Post A Read” call (defined below). Message type filtering is performed on the message types defined in the DCII protocol, however, filtering of specific messages on any protocol may be performed, with the constraint that the protocol uses a message identifier which is resident in the message header as it is transmitted.

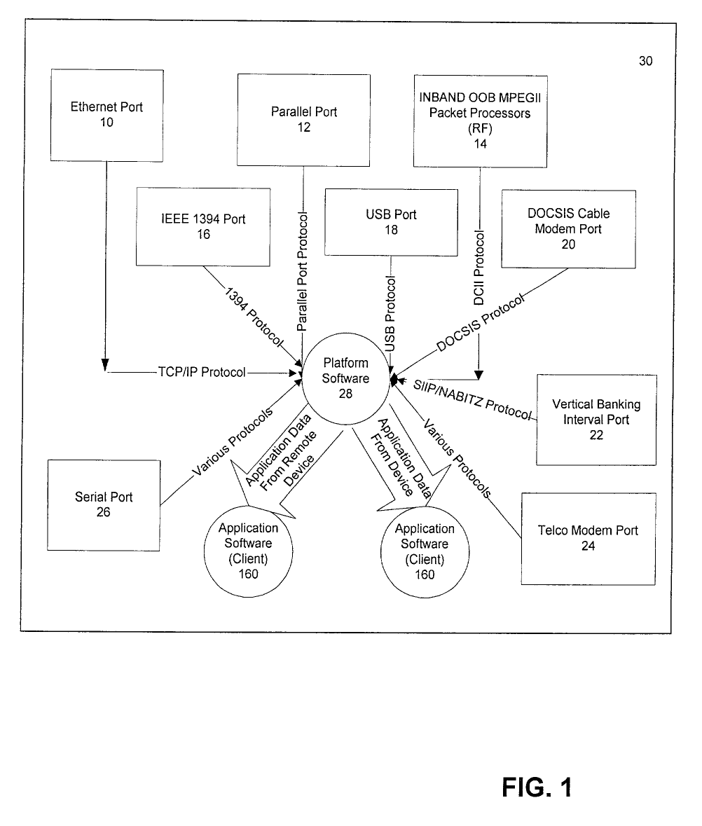

As noted above, the client application 160 issues a “Post A Read” call indicating that the client application is ready to receive a message. A separate “Post A Read” call is issued each time the client application 160 is ready to receive a message. The client application 160 has the ability to queue more than one posted read at any time. This “Post A Read” call advantageously provides a flow control mechanism limiting the flow of input data destined for a particular client application 160 to the rate the client application 160 is actually able to process that data. When a message comes in from an input port (e.g., input ports 10, 12, 14, 16, 18, 20, 22, 24, and 26 as shown in FIG. 1) via its associated Device Driver (e.g., Device Drivers 210, 220, 230, 240, 250, and 260), the Control Channel Router 140 looks in the Connection Store 120 to determine if any client application 160 has an established connection for this message or stream of messages from this input port, and if a Post A Read command has been issued for this data by the client application 160. If the client application 160 has not posted a read then the message is discarded.

This above-described mechanism forces the client application 160 to process messages that have been sent to the client application 160 before receiving additional messages. This advantageously prevents the problems of conventional terminal devices where messages are sent to client applications 160 based solely on an established connection and that a message was received at the input port. Thus, in conventional terminals the rate of the message distribution to a client application 160 is based upon on the speed at which the data was received at the input port, and the faster the input data, the more messages are routed to a particular client application 160. This poses a particular problem in the broadband environment in that if every data source increased the speed of the input data in order to increase their client's respective priority, catastrophic results would occur. The “Post A Read” mechanism acts as a “gating” factor to determine how often the client application 160 runs and actually processes messages. In this way, the priority of the client's thread controls the priority at which the third party client application 160 receives input data and is a preferred way to handle the flow control issue.

The Control Channel Message Router (CCR) 140 addresses the need of hiding the client application 160 from the hardware details and protocol knowledge that are specific to a particular broadband environment. The Control Channel Message Router 140 includes protocol support 200 for the handling of the message structure defined in a variety of different communication protocols, e.g., DCT message stream protocol, DSMCC protocol, Ethernet protocols, IP Protocols, USB protocol, and the like. When a message comes in from a specific input port, the CCR 140 recognizes where it came from and builds a message body required for that protocol. For instance, in the case of the VBI port, a particular byte of the input message is monitored to determine if the incoming message is to be decoded using the NABITZ or SLIP protocols. This allows the client application 160 to be isolated from the protocol being used to transmit the data, as the CCR 140 only sends the payload portion of the message to the client application.

The CCR 140 further provides support for DCII segment reassembly and IP fragment reassembly. This support is provided so that the client application 160 will always receive the entire message and not have to re-assemble pieces of messages, which serves to reduce redundant code in many client applications, save code space, and reduce the occurrence of programming errors. The reassembly algorithms preferably incorporate the use of aging timers for each path for cases where an entire message cannot be built in a specified amount of time. Once the reassembly process is completed, the CCR 140 sends the payload portion of the message to the client application 160.

The CCR 140 also provides for reception of input messages from an extensible set of hardware mediums. The CCR 140 provides a generic interface for the low-level device drivers (210, 220, 230, 240, 250 and 260) to asynchronously provide data when their respective input port receives it. This generic interface also provides a way to prioritize one port over another. For instance, in the broadband environment the Control Channel that is connected to the addressable controller must be prioritized over, e.g., the IEEE1394 port (input port 16 of FIG. 1).

The CCR 140 provides an advanced message filtering mechanism that allows client defined filtering of messages. The Connection Store 120 implements this feature and provides a location to house information regarding each client application 160 actively receiving data. Typical information that is kept in the Connection Store 120 includes specific client application's message filtering information, information required to forward messages to the client applications, Post A Read requests, information regarding the specific message type the client application 160 is requesting, or the path the client application 160 wants to receive messages from. Each time a message is received from an input path, the connection store information is sorted to determine what client application 160 has requested this data. Additionally, the CCR 140 provides a generic message class interface that can be refined to support different protocols and or products without changing the basic structure of the code.

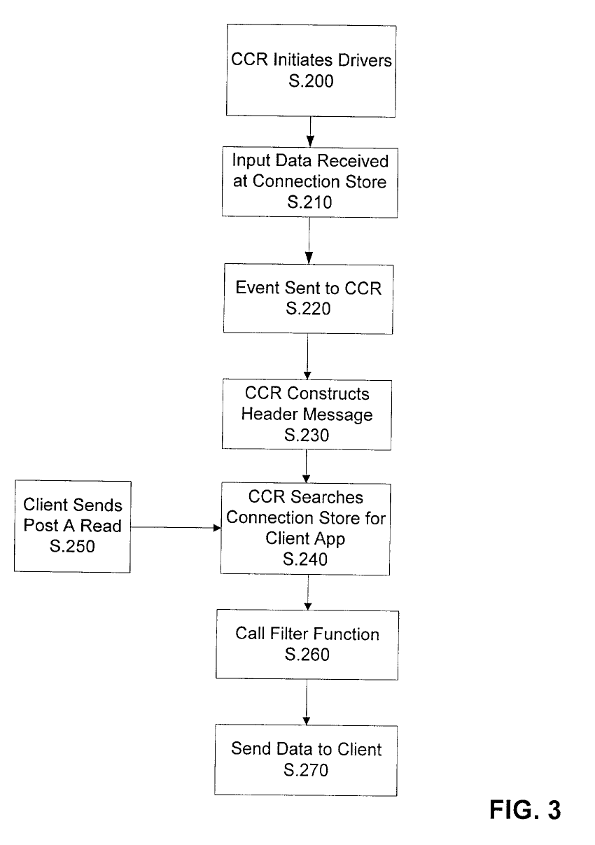

Referring now to FIG. 3, there is illustrated an overview of the processes performed by the broadband terminal 30 in routing messages to client applications 160. In accordance with the present invention, when the broadband terminal 30 performs its initialization routines, the CCR 140 initializes all device drivers (e.g., device drivers 210, 220, 230, 240, 250, and 260 of FIG. 2) that provide asynchronous input data (S.200). The terminal 30 relies on asynchronous events, which initiate the routing of data to the various client applications 160. As data is input into the broadband terminal (S.210), the device driver alerts the Control Channel Router 140 via an event mechanism (S.220). The Control Channel Router 140 then constructs a header of the message relevant to this particular port (S.230). Next, the Control Channel Router 140 searches through the Connection Store 120 to see if there is a client application 160 for which this data is destined (S.240). There will be destination client applications if client applications 160 have sent a Post A Read to the CCR 140 (S.250). If there is a destination client application 160, then the client application's Filter Function, as described above, is called on the message (S.260) as a final check before the client's “Send Response” method is called (S.270).

It should now be appreciated that the broadband terminal described above has many advantages over conventional terminals. In particular, the broadband terminal of the present invention advantageously controls message distribution and routing to client applications running within the terminal. Also, it is noted that the broadband terminal message distribution mechanism is preferably scalable with respect to adding new devices as input sources and new application clients during runtime operation. Also the broadband terminal message distribution mechanism design provides a flow control mechanism so that one client does not dominate all the downstream bandwidth, while being flexible with respect to the number of clients that can be supported at any one given time and adding new protocols for a given path. A farther consideration is that the invention is designed not to be specific to a particular hardware environment or a particular Operating System environment.

Although the invention has been described in connection with various illustrated embodiments, numerous modifications and adaptations may be made thereto without departing from the spirit and scope of the invention as set forth in the claims.

What is claimed is:

1. A mechanism in a broadband terminal for managing downstream data distributed from remote devices to client applications via a plurality of diverse input ports, comprising:
a control channel router that receives messages containing the downstream data from the input ports and distributes the data to the client applications in accordance with client application requests for the data; and
a service acquisition interface that enables the client applications to establish connections to receive the data by requesting the data independently of one of a message protocol or a port from which the data is received by said broadband terminal device.

2. The mechanism as recited in claim 1, wherein:
said connections are established by client applications using a generic source name; and said generic source name is independent of one of a port from which the data is to be received or a protocol by which the data is communicated.

3. The mechanism as recited in claim 2, further comprising:
a connection store that stores specific hardware and service acquisition-related information to establish said connections between the client applications and ports from which the data is to be received, wherein said connection store comprises posted read requests that the client applications issue when they are ready to receive data.

4. The mechanism as recited in claim 2, wherein the generic source name correlates to one of a specific path, a specific port, and a specific device from which the data is to be received.

5. The mechanism as recited in claim 1, wherein:
said service acquisition interface provides an abstraction of a source of the downstream data; and
said service acquisition interface provides client application portability from one broadband environment to another, different broadband environment.

6. The mechanism as recited in claim 5, wherein client application requests for downstream data are prioritized in accordance with predetermined criteria so that a particular client application's requests for data are controlled such that other client applications remain capable of receiving data when requested by said other client applications.

7. The mechanism as recited in claim 6, wherein said predetermined criteria comprises one of a priority of a specific input port from which the downstream data is to be received, and a priority of a particular client application's thread.

8. The mechanism as recited in claim 6, further comprising a connection store, wherein said connection store provides each client application program with a connection ID, which is used to make said client application requests for the data.

9. The mechanism as recited in claim 6, wherein said client application requests are made only when client applications are ready to receive the data.

10. The mechanism as recited in claim 1, wherein said control channel router determines from which port the message is received, determines a protocol associated with that port and message, and distributes only the payload portion of the received message containing the downstream data to client applications.

11. The mechanism as recited in claim 10, further comprising a connection store that maintains information regarding each client application program, including said client application requests, wherein said control channel router distributes data in accordance with information maintained in said connection store.

12. The mechanism as recited in claim 1, wherein:
the control channel router is adapted to perform filtering of downstream data as defined by each client application program; and
the control channel router delivers the downstream data in accordance with each client application's filter function.

13. A terminal device adapted to operate within a broadband environment and running a plurality of client applications and a mechanism for managing downstream data distributed from remote devices to the client applications, comprising:
a plurality of diverse input ports that receive data; and
platform software residing on said terminal device that controls the processing of the data in accordance with client application requests for the data and a predetermined priority of said input ports.

14. The terminal device recited in claim 13, wherein:
said client applications establish a connection to receive data by identifying a generic source name to said platform software: and
said generic source name is independent of said input ports.

15. The terminal device recited in claim 14, wherein the platform software uses said generic source name to determine a corresponding input port from which data is to be routed to the client applications.

16. The terminal device as recited in claim 13, wherein:
said platform software provides an abstraction of a source of the downstream data; and
said platform software provides client application portability from one broadband environment to another, different broadband environment.

17. The terminal device as recited in claim 16, wherein client application requests for downstream data are prioritized in accordance with predetermined criteria, so that a particular client application's requests for data are controlled such that other client applications remain capable of receiving data when requested by said other client applications.

18. The terminal device as recited in claim 17, wherein said predetermined criteria comprises one of a priority of a specific input port from which the downstream data is to be received, and a priority of a particular client application's thread.

19. The terminal device as recited in claim 13, wherein:
the platform software is adapted to perform filtering of downstream data as defined by each client application program; and
the platform software delivers the downstream data in accordance with each client application's filter function.

20. A method of routing downstream data to client applications within a broadband terminal device from at least one input port, comprising:
receiving, at a router, an event indicative of the receipt of a message at an input port;
searching through a database to determine if there is a client application for which the data contained in the message is destined; and
sending the data to the client if there is a client application for which the data is destined, or otherwise discarding the message.

21. The method as recited in claim 20, wherein the client applications asynchronously request data by issuing requests that are stored in said database.

22. The method as recited in claim 20, further comprising:
prioritizing client application requests for data in accordance with one of the input port which receives the data and the client application's thread.

23. The method as recited in claim 22, wherein the client application requests for data are made by specifying a generic source name independent of an input port which receives the data.

24. The method as recited in claim 20, further comprising calling a filter function to filter received downstream data in accordance with client defined filtering function.
